(19) United States
(12) Patent Application Publication
(10) Pub. No.: US 2017/0277446 A1
(43) Pub. Date: Sep. 28, 2017

(54) MEMORY CONTROLLER AND STORAGE DEVICE INCLUDING THE SAME

(71) Applicant: SAMSUNG ELECTRONICS CO., LTD., Suwon-si (KR)

(72) Inventor: WOO SEONG CHEONG, SUWON-SI (KR)

(21) Appl. No.: 15/459,048

(22) Filed: Mar. 15, 2017

(30) Foreign Application Priority Data
Mar. 23, 2016 (KR) 10-2016-0034850

(51) Int. Cl. G06F 3/06; G06F 1/32

(52) U.S. Cl. CPC G06F 3/0613; G06F 3/0679; G06F 3/0659; G06F 3/0634; G06F 1/3287; G06F 3/0607

(57) ABSTRACT

A memory controller includes a host interface configured to output at least one among a plurality of pieces of control information on the basis of data or a command received from a host. A lower-power mode entry controller is configured to select and output at least one among a plurality of control signals on the basis of at least one among the plurality of pieces of control information. The lower-power mode entry controller outputs the plurality of control signals to run a low-power mode in which power consumption is decreased. The plurality of pieces of control information include operation information representing a read operation or a write operation, pattern information representing a random operation or a sequential operation, and speed information representing a throughput of the host per unit time.

### CROSS-REFERENCE TO RELATED APPLICATION

This application claims the benefit of Korean Patent Application No. 10-2016-0034850 filed on Mar. 23, 2016, in the Korean Intellectual Property Office, the disclosure of which is incorporated herein in its entirety by reference.

### BACKGROUND

One or more embodiments of the disclosure relates to a memory controller and a storage device including the same, and more particularly, to a memory controller capable of efficiently managing power consumption and performance thereof according to data or a command received from a host, and a storage device including the same.

In general, a storage device including a nonvolatile memory (e.g., a solid-state drive (SSD)) uses a high-speed serial interface which operates at a high speed, e.g., Gbits/s, such as a serial advanced technology attachment (SATA) interface, a peripheral component interconnect express (PCIe) interface, or a universal flash storage (UFS) interface. It is important to manage power consumption of such a device while in operation or an idle state.

There is a trade-off between device performance and power consumption. Thus, the device performance should be lowered to decrease power consumption. Accordingly, there is a need to decease power consumption by controlling the performance of a storage device according to the interface performance of a host.

### SUMMARY

According to an aspect of the disclosure, a memory controller includes a host interface configured to output at least one among a plurality of pieces of control information on the basis of data or a command received from a host. A lower-power mode entry controller is configured to select and output at least one among a plurality of control signals on the basis of at least one among the plurality of pieces of control information. The lower-power mode entry controller outputs the plurality of control signals to run a low-power mode in which power consumption is decreased. The plurality of pieces of control information include operation information representing a read operation or a write operation, pattern information representing a random operation or a sequential operation, and speed information representing a throughput of the host per unit time.

According to another aspect of the disclosure, a storage device includes a power management integrated circuit (PMIC), a memory controller, a buffer, and a nonvolatile memory. The memory controller includes a host interface configured to output at least one among a plurality of pieces of control information on the basis of data or a command received from a host, a lower-power mode entry controller configured to select and output at least one among a plurality of control signals on the basis of at least one among the plurality of pieces of control information, and a central processing unit (CPU) configured to control or operate the lower-power mode entry controller. The plurality of pieces of control information includes operation information representing a read operation or a write operation, pattern information representing a random operation or a sequential operation, and speed information representing a throughput of the host per unit time. The host interface includes an operation detector configured to generate the operation information on the basis of the command or the data received from the host, a pattern detector configured to generate the pattern information on the basis of the command or the data received from the host, and a speed measurer configured to generate the speed information on the basis of the data received from the host. The speed measurer measures the throughput of the host per unit time by counting blocks of data received for the unit time and generates the speed information.

According to another aspect of the disclosure, a storage device includes a nonvolatile memory, a memory buffer, and a memory controller. The memory controller programs information into the nonvolatile memory, reads the programmed information from the nonvolatile memory, and controls the power consumed by the storage device in accordance with data or a command received from an external host. The power consumed by the storage device is varied by controlling: (1) operating voltages provided to the nonvolatile memory, the buffer or the memory controller, (2) the frequency of a clock signal provided to the nonvolatile memory, the buffer or the memory controller, (3) whether the memory buffer is activated for temporarily storing buffer data communicated between the nonvolatile memory and the host, or (4) which one or more of a plurality of data storage regions within the nonvolatile memory is activated for operational use.

### BRIEF DESCRIPTION OF THE DRAWINGS

Example embodiments of the disclosure will be more clearly understood from the following detailed description taken in conjunction with the accompanying drawings in which:

FIG. 1 is a block diagram of a data processing system according to an embodiment of the disclosure;

FIG. 2 is a perspective view of a storage device according to some embodiments of the disclosure;

FIG. 3 is a detailed block diagram of a nonvolatile memory according to some embodiments of the disclosure;

FIG. 4 is a detailed block diagram of a host interface according to some embodiments of the disclosure;

FIG. 5 is a flowchart of a method of operating a storage device according to some embodiments of the disclosure;

FIG. 6 is a detailed flowchart of determining whether a low-power mode is to be entered, included in the method of FIG. 5;

FIG. 7 is a block diagram of a data processing system according to some embodiments of the disclosure;

FIG. 8 is a block diagram of a data processing system according to some embodiments of the disclosure;

FIG. 9 is a block diagram of a data processing system according to some embodiments of the disclosure; and

FIG. 10 is a block diagram of a data processing system according to some embodiments of the disclosure.

### DETAILED DESCRIPTION OF THE EMBODIMENTS

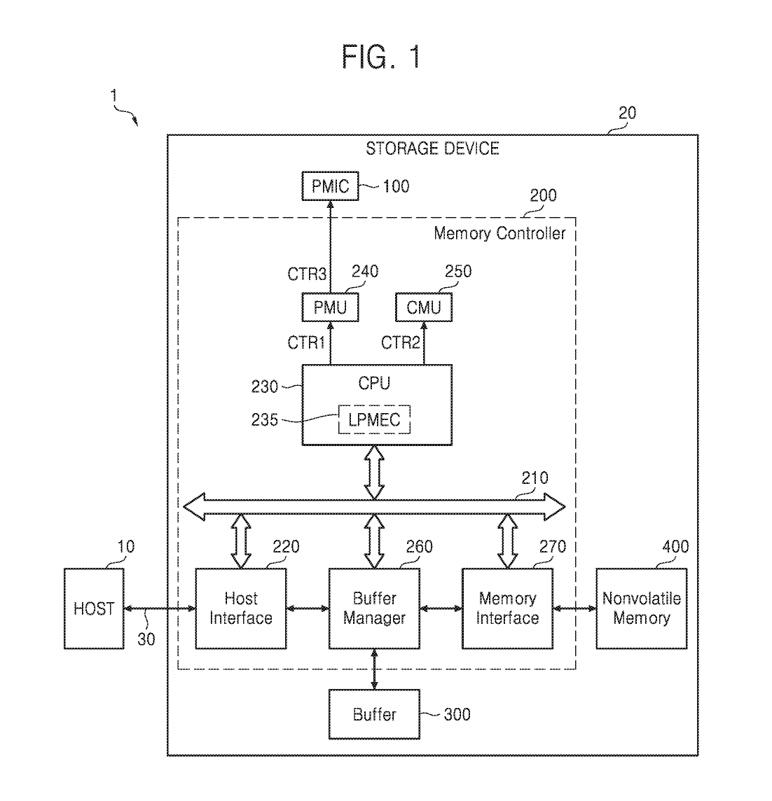

FIG. 1 is a block diagram of a data processing system 1 according to an embodiment of the disclosure. Referring to FIG. 1, the data processing system 1 may include a host 10, a storage device 20, and an interface 30. For example, the data processing system 1 may be understood as a memory system.

In some embodiments, the data processing system 1 may be embodied as a personal computer (PC), a workstation, a data center, an internet data center (IDC), a storage area network (SAN), a network attached storage (NAS) device, or a mobile computing device but is not limited thereto.

The mobile computing device may be a laptop computer, a mobile phone, a smart phone, a tablet PC, a personal digital assistant (PDA), an enterprise digital assistant (EDA), a digital still camera, a digital video camera, a portable multimedia player (PMP), a personal/portable navigation device (PND), a handheld game console, a mobile internet device (MID), a wearable computer, an internet-of-things (IoT) device, an internet-of-everything (IoE) device, a drone, or an e-book.

The host 10 may control a data processing operation (e.g., a write operation, a read operation, or the like) of the storage device 20. The host 10 may be understood as a host controller.

The host 10 may transmit, to the storage device 20, a write request to write data to the storage device 20 or a read request to read data from the storage device 20. The write request may include a write address. The read request may include a read address. The term “request” may be understood as a command.

The host 10 may transmit data to or receive data from the storage device 20 via the interface 30.

The interface 30 may be embodied as, but is not limited to, a serial advanced technology attachment (SATA) interface, a SATA express (SATAe) interface, a serial attached-small computer system interface (SCSI) (SAS), a peripheral component interconnect express (PCIe) interface, a non-volatile memory express (NVMe) interface, an advanced host controller interface (AHCI) interface, or a multimedia card (MMC) interface.

In one embodiment, the host 10 may be embodied as, but is not limited to, an integrated circuit (IC), a motherboard, a system-on-chip (SoC), an application processor (AP), a mobile AP, a web server, a data server, or a database server.

In some embodiments, the interface 30 may transmit electrical signals or optical signals.

The storage device 20 may exchange a command and/or data with the host 10 via the interface 30.

The storage device 20 may be embodied as a flash memory-based memory device but is not limited thereto. For example, the storage device 20 may be embodied as, but is not limited to, an SSD, an embedded SSD (eSSD), a universal flash storage (UFS) device, an MMC, an embedded MMC (eMMC), or a managed NAND memory. The flash memory-based memory device may be a NAND-type flash memory device or a NOR-type flash memory device.

In some embodiments, the storage device 20 may be embodied as, but is not limited to, a hard disk drive (HDD), a phase-change random access memory (PRAM) device, a magneto-resistive RAM (MRAM) device, a spin-transfer torque MRAM (STT-MRAM) device, a ferroelectric RAM (FRAM) device, or a resistive RAM (RRAM) device.

The storage device 20 may include a power management integrated circuit (PMIC) 100, a memory controller 200, a buffer 300, and a nonvolatile memory 400.

The PMIC 100 may supply power (or operating voltages) to the memory controller 200, the buffer 300, and the nonvolatile memory 400 under control of the memory controller 200. For example, the operating voltages respectively supplied to the memory controller 200, the buffer 300, and the nonvolatile memory 400 may be the same or different.

The memory controller 200 may control the nonvolatile memory 400 and the PMIC 100. In some embodiments, the memory controller 200 may be embodied as an IC, an SoC, a processor, an AP, a chipset, or a set of semiconductor chips.

The memory controller 200 may control transmission or processing of a command and/or data exchanged between the host 10 and the nonvolatile memory 400.

The memory controller 200 may include a bus 210, a host interface 220, a central processing unit (CPU) 230, a power management unit (PMU) 240, a clock management unit (CMU) 250, a buffer manager 260, and a memory interface 270.

The bus 210 may be, but is not limited to, an advanced microcontroller bus architecture (AMBA), an advanced high-performance bus (AHB), an advanced peripheral bus (APB), an advanced extensible interface (AXI), an advanced system bus (ASB), an AXI coherency extensions (ACE), or a combination thereof.

The host interface 220 may change a format of data, DATA, to be transmitted to the host 10, and transmit the data having the changed format to the host 10 via the interface 30. Furthermore, the host interface 220 may receive data, DATA, or a command CMD from the host 10. In addition, the host interface 220 may change a format of either the data, DATA, or the command CMD, and transmit the data, DATA, or command CMD having the changed format to the CPU 230 or the buffer manager 260.

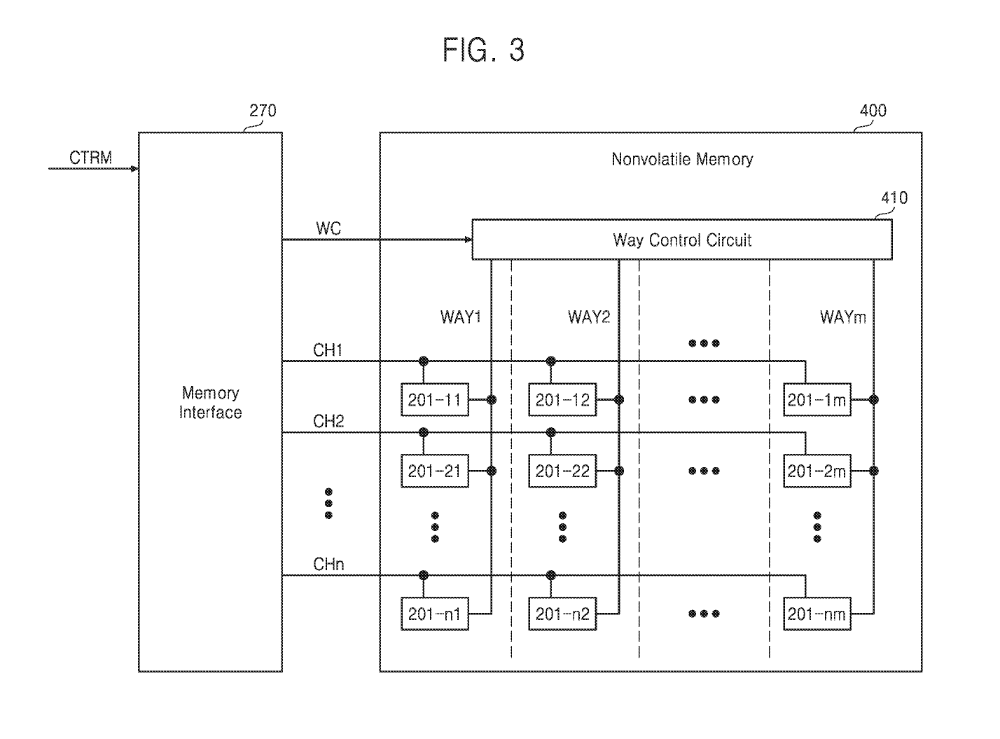

The host interface 220 may output at least one among a plurality of pieces of control information OP, PT, and SP on the basis of the data, DATA, or the command CMD received from the host 10. The plurality of pieces of control information OP, PT, and SP may include operation information OP representing the read operation or the write operation, pattern information PT representing a random operation or a sequential operation, and speed information SP representing a throughput of the host 10 per unit time. For example, the host interface 220 may generate the operation information OP or the pattern information PT on the basis of the data, DATA, or the command CMD. Furthermore, the host interface 220 may measure the throughput of the host 10 per unit time by counting blocks of the data, DATA, received per unit time, and generate the speed information SP. The host interface 220 may transmit at least one among the plurality of pieces of control information OP, PT, and SP to a lower-power mode entry controller (LPMEC) 235. The above operation of the host interface 220 may be performed at a D-PHY layer or a link layer as will be described in detail with reference to FIG. 3 below, but embodiments of the disclosure are not limited thereto.

The host interface 220 may output the data, DATA, or the command CMD received from the host 10 to the bus 210 or the buffer manager 260. The host interface 220 may transmit data output from the buffer manager 260 to the host 10. The host interface 220 may use a protocol appropriate for the interface 30.

A structure and operation of the host interface 220 may be embodied to be appropriate for those of the interface 30. For example, the host interface 220 may be embodied as, but is not limited to, an SATA interface, an SATAe interface, an SAS interface, a PCIe interface, an NVMe interface, an AHCI interface, an MMC interface, a NAND-type flash memory interface, or a NOR-type flash memory interface.

The CPU 230 may control the elements 210, 220, 235, 240, 250, 260, and 270. For example, the CPU 230 may operate or control the lower-power mode entry controller 235.

The lower-power mode entry controller 235 may control entry of the storage device 20 or the memory controller 200 into a low-power mode, and generate a plurality of control signals CTR1 and CTR2. The low-power mode may be understood as a power-save mode. The low-power mode may be understood as a low-power mode of the storage device 20 or the memory controller 200.

The low-power mode may be understood as at least one of: controlling at least one of a clock signal and an operating voltage to be supplied to at least one among the elements 210, 220, 230, 234, 240, 250, 260, and 270 included in the storage device 20 so as to reduce power consumption of the storage device 20, controlling an operation of the nonvolatile memory 400, and controlling the buffer 300.

That is, the lower-power mode entry controller 235 may employ a dynamic frequency scaling (DFS) algorithm, a dynamic voltage and frequency scaling (DVFS) algorithm, a dynamic power management (DPM) policy, or a combination thereof. The DPM policy means selectively shutting down idle or underused system components to reduce power dissipation in the system.

The lower-power mode entry controller 235 may be embodied by hardware or software.

When the lower-power mode entry controller 235 is embodied by software, the lower-power mode entry controller 235 may be operated under control of the CPU 230 as illustrated in FIG. 1. When the lower-power mode entry controller 235 is embodied by hardware, the lower-power mode entry controller 235 may be included as a separate component in the memory controller 200 unlike that illustrated in FIG. 1, and may independently operate without control of the CPU 230. However, embodiments of the disclosure are not limited thereto.

The PMU 240 may generate a third control signal CTR3 for controlling the PMIC 100, in response to the first control signal CTR1 output from the CPU 230. The PMIC 100 may control (increase, maintain, or reduce) a voltage to be applied to at least one among the elements 210, 220, 230, 235, 240, 250, 260, and 270, in response to the third control signal CTR3.

The CMU 250 may control a frequency of a clock signal to be supplied to at least one among the elements 210, 220, 230, 235, 240, 250, 260, and 270, in response to the second control signal CTR2 output from the CPU 230. For example, the CMU 250 may perform clock gearing, increase the frequency of the clock signal, maintain the frequency of the clock signal constant, or reduce the frequency of the clock signal.

The clock gearing should be understood as a method of controlling the frequency of the clock signal by removing teeth of the clock signal (e.g., rising or falling pulses occurring periodically) rather than directly changing the frequency of the clock signal using a phase-locked loop. For example, clock gearing may be performed by substantially reducing the frequency of the clock signal by removing fifty teeth among every one hundred teeth of the clock signal.

The buffer manager 260 may write data to or read data from the buffer 300 under control of the CPU 230. Data processed by the buffer manager 260 may be transmitted to the host interface 220 or the memory interface 270. The buffer manager 260 may be referred to as a buffer controller capable of controlling performing the write operation and the read operation on the buffer 300.

The buffer 300 may store a power table. The power table may store information enabling the lower-power mode entry controller 235 to determine whether the low-power mode is to be entered or to determine an optimum low-power mode among a plurality of low-power modes on the basis of at least one among the plurality of pieces of control information OP, PT, and SP.

The power table may have been stored during development of a product according to the performance of the host 10 so that power consumption of the storage device 20 may be optimized. For example, the power table may store information regarding whether the low-power mode is to be entered, an optimum low-power mode, an entry time, an entry speed, etc. according to the plurality of pieces of control information OP, PT, and SP. Although not shown in FIG. 1, the memory controller 200 may further include a direct memory access (DMA) controller.

The DMA controller may transmit data from the buffer manager 260 to the memory interface 270 or transmit data output from the memory interface 270 to the buffer manager 260.

The memory interface 270 may control performing of the write operation (or a program operation) and the read operation on the nonvolatile memory 400, under control of the CPU 230 or the DMA controller. Furthermore, the memory interface 270 may set channels or ways for performing the write operation (or the program operation) and the read operation, as will be described in detail with reference to FIG. 3 below.

In some embodiments, the memory interface 270 may be embodied as, but is not limited to, an SATA interface, an SATAe interface, an SAS interface, a PCIe interface, an NVMe interface, an AHCI interface, an MMC interface, a NAND-type flash memory interface, or a NOR-type flash memory interface.

The buffer 300 may be embodied as a volatile memory, such as a RAM, a dynamic RAM (DRAM), a static RAM (SRAM), a buffer memory, a cache, or a tightly coupled memory; or a nonvolatile memory device such as a NAND flash memory, but embodiments of the disclosure are not limited thereto.

The buffer 300 may include, but is not limited to, a first memory region storing a mapping table for logical address-to-physical address conversion of the nonvolatile memory 400, a second memory region capable of performing a cache function, and a third memory region storing a power table. For example, a flash translation layer (FTL) executed by the CPU 230 may perform logical address-to-physical address conversion using the mapping table stored in the first memory region.

In one embodiment, when the memory controller 200 and the buffer 300 are different chips, the memory controller 200 and the buffer 300 may be embodied as one package, e.g., a package-on-package (PoP), a multi-chip package (MCP), or a system-in package (SiP) but embodiments of the disclosure are not limited thereto. For example, a first chip including the buffer 300 may be stacked above a second chip including the memory controller 200 via stack balls.

The nonvolatile memory 400 may include a plurality of clusters 201. Data, DATA, may be stored in the plurality of clusters 201 under control of the memory controller 200, as will be described in detail with reference to FIG. 3 below.

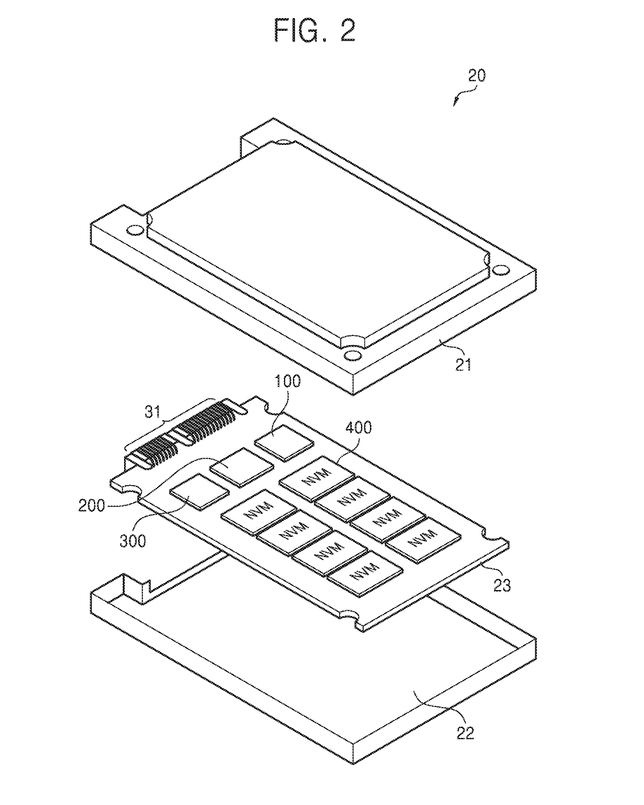

FIG. 2 is a perspective view of a storage device 20 according to some embodiments of the disclosure.

Referring to FIGS. 1 and 2, the storage device 20 may be embodied as an SSD. The storage device 20 which is an SSD may include a top cover 21, an interface connector 31 connected to the interface 30, the PMIC 100, the memory controller 200 (e.g., an SSD controller), the buffer 300 (e.g., a DRAM device), the nonvolatile memory 400, and a bottom cover 22.

The elements 100, 200, 300, and 400 may be packaged into a semiconductor package. The nonvolatile memory 400 may be located on one surface or opposite surfaces of a printed circuit board (PCB) 23.

FIG. 3 is a detailed block diagram of a nonvolatile memory 400 according to some embodiments of the disclosure.

Referring to FIGS. 1 to 3, the nonvolatile memory 400 may include a way control circuit 410 and a plurality of clusters 201-11 to 201-nm. Here, n and m each denote a natural number which is greater than or equal to ‘3’.

A memory interface 270 may exchange data, DATA, with the plurality of clusters 201-11 to 201nm via a plurality of channels CH1 to CHn. For example, the memory interface 270 may exchange the data, DATA, with the clusters 201-11 to 201-1m corresponding to the first channel CH1 among the plurality of clusters 201-11 to 201-nm via the first channel CH1.

The memory interface 270 may activate only corresponding channels among the plurality of channels CH1 to CHn according to a memory control signal CTRM received from the CPU 230.

Furthermore, the memory interface 270 may output a way control signal WC to the way control circuit 210 according to the memory control signal CTRM received from the CPU 230.

The way control circuit 210 may activate only corresponding ways among a plurality of ways WAY1 to WAYm according to the way control signal WC received from the memory interface 270.

In some embodiments, the way control circuit 210 may be included in either the memory interface 270 or each of the clusters 201-11 to 201-nm unlike that illustrated in FIG. 3. However, embodiments of the disclosure are not limited thereto.

Each of the plurality of clusters 201-11 to 201-nm may be embodied as a NAND-type flash memory device. Each of the plurality of clusters 201-11 to 201-nm may include a memory cell array, and a control logic circuit (not shown) which controls operations (e.g., a write operation and a read operation) of the memory cell array.

The memory cell array may include a two-dimensional (2D) memory cell array or a three-dimensional (3D) memory cell array. The 3D memory cell array may include a circuit which is formed monolithically within one or more physical levels of an array of memory cells having an array region on or above a silicon substrate and which is related to operations of the memory cells. The circuit may be formed inside, on, or above the silicon substrate.

The term “monolithic” means direct deposition of layers of each level of an array on layers of each underlying level of the array.

The 3D memory cell array may include a vertical NAND string vertically oriented such that at least one memory cell is located on another memory cell. The at least one memory cell may include a charge trap layer.

The memory cell array may include a plurality of memory cells. Each of the plurality of memory cells may be embodied as a single-level cell (SLC) capable of storing 1-bit information or a multi-level cell (MLC) capable of storing 2-bit information or more. The information may be understood as logic ‘1’ or logic ‘0’.

In the present disclosure, the term “channel” may be understood as an independent data path between the memory controller 200 (particularly, the memory interface 270) and one channel corresponding thereto. The data path may include transmission lines via which data and/or control signals are transmitted.

The term “way” may be understood as a group of one or more clusters sharing one main channel Thus, a plurality of ways may be connected to one main channel. The memory controller 200 may control n channelsxm ways.

As described above, the memory interface 270 may activate some of the plurality of clusters 201-11 to 201-nm, thereby reducing power consumption.

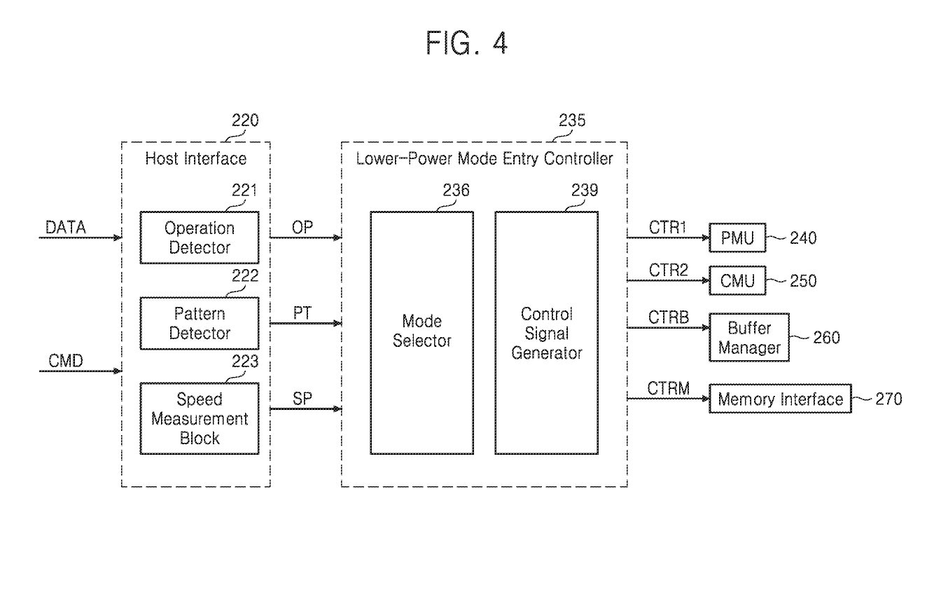

FIG. 4 is a detailed block diagram of a host interface according to some embodiments of the disclosure. For convenience of explanation, FIG. 4 also illustrates a lower-power mode entry controller 235, a PMU 240, a CMU 250, a buffer manager 260, and a memory interface 270.

Although FIG. 4 illustrates that the lower-power mode entry controller 235 is embodied by hardware independently from the CPU 230, the lower-power mode entry controller 235 may be embodied by software executed or controlled by the CPU 230 according to some embodiments.

The lower-power mode entry controller 235 may output a plurality of control signals CTR1, CTR2, CTRM, and CTRB.

Referring to FIG. 4, the host interface 220 may include an operation detector 221, a pattern detector 222, and a speed measurement block 223.

The operation detector 221 may generate operation information OP of an operation to be performed by the storage device 20 on the basis of a command CMD or data, DATA, received from the host 10. The operation information OP may represent a read operation or a write operation. The operation detector 221 may transmit the operation information OP to the lower-power mode entry controller 235.

The pattern detector 222 may generate pattern information PT of an operation to be performed by the storage device 20 on the basis of the command CMD or the data, DATA, received from the host 10. The pattern information PT may represent a random operation or a sequential operation. The pattern detector 222 may transmit the pattern information PT to the lower-power mode entry controller 235.

The speed measurement block 223 may measure a throughput of the host 10 per unit time on the basis of the data, DATA, received from the host 10, and generate speed information SP representing the throughput of the host 10 per unit time. In detail, the speed measurement block 223 may measure the throughput of the host 10 per unit time by counting the data, DATA, received from the host 10 or blocks of the data, DATA, for a unit time. For example, the speed measurement block 223 may generate the speed information SP representing speed in a unit of MB/s (megabytes per second). In some embodiments, for example, the speed measurement block 223 may generate the speed information SP representing speed in a unit of IOPS (input/output operations per second).

The speed measurement block 223 may transmit the speed information SP to the lower-power mode entry controller 235.

In some embodiments, unlike that illustrated in FIG. 4, the operation detector 221, the pattern detector 222, and the speed measurement block 223 may be located outside the host interface 220, and may be each embodied by software. However, embodiments of the disclosure are not limited thereto.

As described above, the CPU 230 may control or operate the lower-power mode entry controller 235.

The lower-power mode entry controller 235 may control entry into the low-power mode, and generate the control signals CTR1, CTR2, CTRM, and CTRB. The low-power mode may be understood as a power-save mode. The low-power mode may be understood as a low-power mode of the storage device 20 and/or the memory controller 200. In detail, the lower-power mode entry controller 235 may determine whether the low-power mode is to be entered on the basis of at least one among the operation information OP, the pattern information PT, and the speed information SP, and may select one of a plurality of low-power modes when it is determined that the low-power mode is to be entered.

The lower-power mode entry controller 235 may include a mode selector 236 and a control signal generator 239.

The mode selector 236 may receive the operation information OP, the pattern information PT, and the speed information SP. The mode selector 236 determines whether the low-power mode is to be entered on the basis of the operation information OP, the pattern information PT, and the speed information SP, and selects one of the plurality of low-power modes when it is determined that the low-power mode is to be entered.

In detail, the mode selector 236 may determine an operation, a pattern, and a transmission rate of the host 10 on the basis of at least one among the operation information OP, the pattern information PT, and the speed information SP. For example, the mode selector 236 may determine that the operation of the host 10 is a sequential read operation and the transmission rate of the host 10 is 90,000 IOPS.

The mode selector 236 may determine whether the low-power mode is to be entered on the basis of a power table. When it is determined that the low-power mode is to be entered, the mode selector 236 may select one of the plurality of low-power modes.

In detail, the mode selector 236 may determine whether the low-power mode is to be entered by inserting at least one among the operation information OP, the pattern information PT, and the speed information SP into the power table stored in the buffer 300. When it is determined that the low-power mode is to be entered, the mode selector 236 may select a corresponding low-power mode among the plurality of low-power modes.

The low-power mode may include at least one of: controlling at least one of a clock signal and an operating voltage to be supplied to at least one among the elements 210, 220, 230, 235, 240, 250, 260, and 270 included in the storage device 20 so as to reduce power consumption in the storage device 20; controlling an operation of the nonvolatile memory 400; and controlling the buffer 300.

For example, a first low-power mode may be a mode of decreasing an operating clock frequency of the storage device 20, a second low-power mode may be a mode of limiting an active region of the nonvolatile memory 400, and a third low-power mode may be a new mode obtained by merging the first low-power mode and the second low-power mode.

For example, when the interface performance of the host 10 is SATA1 and the interface performance of the storage device 20 is SATA3, the lower-power mode entry controller 235 may control the performance of the storage device 20 to be the same as that of the host 10, thereby preventing unnecessary power consumption.

Furthermore, even if the interface performance of the host 10 is SATA3, the lower-power mode entry controller 235 may control the performance of the storage device 20 to be the same as the actual performance of the host 10 when an operation of the host 10 is a sequential read operation and a transmission rate is 4000 IOPS, thereby preventing unnecessary power consumption.

The control signal generator 239 may select and generate at least one among the plurality of control signals CTR1, CTR2, CTRB, and CTRM on the basis of the selected low-power mode.

For example, when a degree of power consumption in the selected low-power mode is substantially the same as that of current power consumption, the control signal generator 239 may generate only the first control signal CTR1 among the plurality of control signals CTR1, CTR2, CTRB, and CTRM. This operation is referred to as a micro-change.

When the degree of power consumption in the selected low-power mode is remarkably different from that of current power consumption, the control signal generator 239 may generate two or more control signals (e.g., the first control signal CTR1, the second control signal CTR2, and the memory control signal CTRM) among the plurality of control signals. This operation is referred to as a macro-change.

The control signal generator 239 may control a point of time when at least one generated control signal is to be output. For example, the control signal generator 239 may continuously measure an operation, a pattern, and a transmission rate of the host 10, and output the generated at least one control signal to a corresponding element when a result of continuously measuring the operation, the pattern, and the transmission rate of the host 10 reaches a threshold. The result of continuously measuring the operation, the pattern, and the transmission rate of the host 10 may be the data transmission rate of the host 10 represented by the speed information SP. The threshold may be a predetermined value.

In addition, the control signal generator 239 may output the generated at least one control signal to the elements 240, 250, 260, and 270 corresponding thereto when a predetermined event occurs (e.g., when the number of defective NAND blocks is greater than or equal to a specific number), when a predetermined time elapses, or when a mode change command is received from the host 10. However, embodiments of the disclosure are not limited thereto.

The control signal generator 239 may output at least one among the plurality of control signals CTR1, CTR2, CTRB, and CTRM to the elements 240, 250, 260, and 270 corresponding thereto at a determined point of time.

The lower-power mode entry controller 235 may repeatedly perform the above operations.

For convenience of explanation, although the control signal generator 239 may directly output the plurality of control signals CTR1, CTR2, CTRM, and CTRB, it will be described below that the lower-power mode entry controller 235 may output these control signals. However, embodiments of the disclosure are not limited thereto.

The lower-power mode entry controller 235 may output the first control signal CTR1 to the PMU 240. The PMU 240 may output the third control signal CTR3 to the PMIC 100 on the basis of the first control signal CTR1. Thus, the lower-power mode entry controller 235 may control the PMIC 100 to change an operating voltage to be applied to at least one among the elements 210, 220, 230, 235, 240, 250, 260, and 270 of the storage device 20.

In addition, the lower-power mode entry controller 235 may output the second control signal CTR2 to the CMU 250 so that the CMU 250 may control a control signal to be supplied to at least one among the elements 210, 220, 230, 240, 250, 260, and 270 of the storage device 20. In detail, the CMU 250 may control the cock signal by changing a frequency of the clock signal or perform clock gearing according to the second control signal CTR2.

The lower-power mode entry controller 235 may output the buffer control signal CTRB to the buffer manager 260 so that the buffer manager 260 may control whether the buffer 300 is to be used.

The lower-power mode entry controller 235 may output the memory control signal CTRM to the memory controller 270 so that the memory controller 250 may activate only a region of the nonvolatile memory 400.

The above operations may be performed independently, and each of the plurality of low-power modes may be designed to correspond to one of the above operations or a combination of the above operations. However, embodiments of the disclosure are not limited thereto.

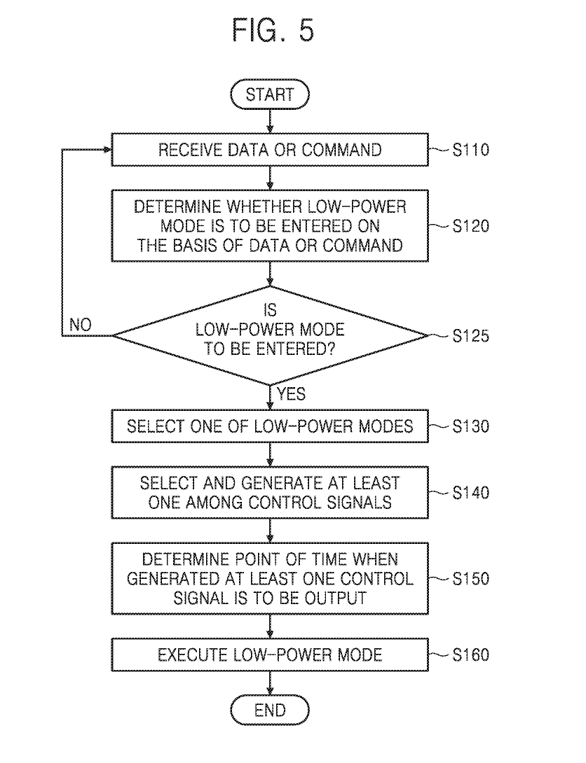

FIG. 5 is a flowchart of a method of operating a storage device according to some embodiments of the disclosure.

Referring to FIGS. 1 and 5, in operation S110, the storage device 20 may receive data, DATA, or a command CMD.

In operation S120, the storage device 20 may determine whether the low-power mode is to be entered on the basis of the data, DATA, or the command CMD. For example, when the performance of the host 10 is lower than that of the storage device 20, the storage device 20 may enter the low-power mode to decrease power consumption.

In operation S130, when it is determined that the low-power mode is to be entered (‘YES’ in operation S125), the storage device 20 may select one of a plurality of low-power modes. For example, the storage device 20 may select one of the plurality of low-power modes on the basis of the data, DATA, or the command CMD. If operation S125 determines that the low-power mode is not to be entered, then execution returns to operation S110.

The low-power mode may include at least one of: decreasing at least one of a clock signal and an operating voltage to be supplied to at least one among the elements 210, 220, 240, 250, 260, and 270 of the storage device 20 so as to decrease power consumption of the storage device 20, controlling an operation of the nonvolatile memory 400, and controlling the buffer 300.

For example, the first low-power mode may be a mode of lowering an operating clock frequency of the storage device 20, a second low-power mode may be a mode of limiting an active region of the nonvolatile memory 400, and the third low-power mode may be a new mode obtained by merging the first low-power mode and the second low-power mode.

For example, when the interface performance of the host 10 is SATA1 and the interface performance of the storage device 20 is SATA3, the lower-power mode entry controller 235 may control the performance of the storage device 20 to be the same as that of the host 10, thereby preventing unnecessary power consumption.

In operation S140, the storage device 20 may select and generate at least one among the plurality of control signals CTR1, CTR2, CTRB, and CTRM on the basis of the selected lower-power mode.

For example, when a degree of power consumption in the selected low-power mode is substantially the same as that of current power consumption, the storage device 20 may generate only the first control signal CTR1 among the plurality of control signals CTR1, CTR2, CTRB, and CTRM.

When the degree of power consumption in the selected low-power mode is remarkably different from that of current power consumption, the storage device 20 may generate two or more control signals (e.g., the first control signal CTR1, the second control signal CTR2, and the memory control signal CTRM) among the plurality of control signals CTR1, CTR2, CTRB, and CTRM.

In operation S150, the storage device 20 may determine a point of time when at least one generated control signal among the plurality of control signals CTR1, CTR2, CTRB, and CTRM is to be output.

For example, the control signal generator 239 may continuously measure an operation, a pattern, and a transmission rate of the host 10, and output at least one generated control signal to an element corresponding thereto when a result of measuring the operation, the pattern, and the transmission rate of the host 10 reaches a threshold.

Furthermore, the control signal generator 239 may output the at least one generated control signal to the elements 240, 250, 260, and 270 corresponding thereto when a predetermined event occurs (e.g., when the number of defective NAND blocks is greater than or equal to a specific number), when a predetermined time elapses, or when a mode change command is received from the host 10. However, embodiments of the disclosure are not limited thereto.

In operation S160, the storage device 20 may execute the low-power mode by outputting the at least one generated control signal at a determined point of time.

The storage device 20 may repeatedly perform the above operations.

These control signals may include the first control signal CTR1, the second control signal CTR2, the third control signal CTR3, the memory control signal CTRM, the buffer control signal CTRB, etc., but embodiments of the disclosure are not limited thereto.

For example, the first control signal CTR1 and the third control signal CTR3 may be signals for controlling an operating voltage to be applied to the storage device 20, the second control signal CTR2 may be a signal for controlling a clock signal to be supplied to the storage device 20, the memory control signal CTRM may be a signal for controlling the nonvolatile memory 400, and the buffer control signal CTRB may be a signal for controlling the buffer 300.

An active region of the nonvolatile memory 400 may be changed according to the memory control signal CTRM. Whether the buffer 300 is to be operated may be determined according to the buffer control signal CTRB.

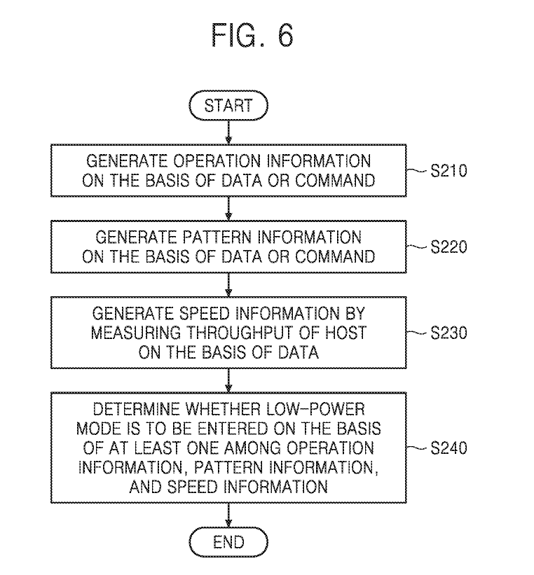

FIG. 6 is a detailed flowchart of the determining of whether the low-power mode is to be entered, which is included in the method of FIG. 5.

Referring to FIGS. 1 and 6 in operation 5210, the storage device 20 may generate operation information OP regarding an operation to be performed by the storage device 20 on the basis of data, DATA, or a command CMD received from the host 10. The operation information OP may represent the read operation or the write operation.

In operation S220, the storage device 20 may generate pattern information PT of an operation to be performed by the storage device 20 on the basis of the data, DATA, or the command CMD received from the host 10. The pattern information PT may represent a random operation or a sequential operation.

In operation S230, the storage device 20 may generate speed information SP by measuring a throughput of the host 10 per unit time, e.g., a transmission rate, on the basis of the data, DATA, received from the host 10. In detail, the speed measurement block 223 may measure the transmission rate of the host 10 by counting data or data blocks received from the host 10 for a unit time.

In some embodiments, the storage device 20 may include the operation detector 221, the pattern detector 222, and the speed measurement block 223.

The operation detector 221, the pattern detector 222, and the speed measurement block 223 may be embodied by software or hardware but embodiments of the disclosure are not limited thereto.

In operation S240, the storage device 20 may determine whether the low-power mode is to be entered on the basis of at least one among the operation information OP, the pattern information PT, and the speed information SP. For example, the storage device 20 may determine whether the low-power mode is to be entered by inserting at least one among the operation information OP, the pattern information PT, and the speed information SP into a power table.

The power table may be a table that has been stored during development of a product such that power consumption of the storage device 20 is optimized according to a specific performance of the host 10. For example, the power table may store not only information as to whether the low-power mode is to be entered but also information regarding a low-power mode to be selected, information regarding an entry time, etc. according to at least one among the operation information OP, the pattern information PT, and the speed information SP.

In some embodiments, the storage device 20 may simultaneously perform operations S210, S220, and S230 or may perform at least one among operations S210, S220, and S230, unlike that illustrated in FIG. 6. However, embodiments of the disclosure are not limited thereto.

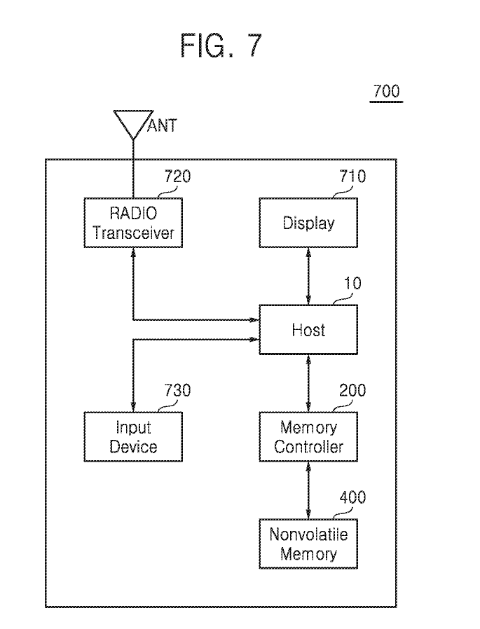

FIG. 7 is a block diagram of a data processing system 700 according to some embodiments of the disclosure. Referring to FIGS. 1 and 7, the data processing system 700 may be implemented as a cellular phone, a smart phone, or a tablet personal computer (PC).

The data processing system 700 includes a host 10 and a nonvolatile memory 400. The nonvolatile memory 400 may be the memory device 130 illustrated in FIG. 1.

According to some embodiments, the host 10 and the nonvolatile memory 400 may be packaged in a package. In this case, the package may be mounted on the system board (not shown).

The host 10 includes a memory controller 200 that can control the test operation of the nonvolatile memory 400 and the data processing operation of the nonvolatile memory 400, for example, a write operation or a read operation.

The memory controller 200 is controlled by the host 10, which controls the overall operation of the data processing system 700. The memory controller 200 may be connected between the host 10 and the nonvolatile memory 400.

The data in the nonvolatile memory 400 may be displayed through a display 710 according to the control of the host 10.

A radio transceiver 720 transmits or receives radio signals through an antenna ANT. The radio transceiver 720 may convert radio signals received through the antenna ANT into signals that can be processed by the host 10. Accordingly, the host 10 may process the signals output from the radio transceiver 720 and store the processed signals in the nonvolatile memory 400 or display the processed signals through the display 710.

The radio transceiver 720 may also convert signals output from the host 10 into radio signals and outputs the radio signals to an external device through the antenna ANT.

An input device 730 enables control signals for controlling the operation of the host 10 or data to be processed by the host 10 to be input to the system 700. The input device 730 may be implemented by a pointing device such as a touch pad or a computer mouse, a keypad, or a keyboard.

The host 10 may control the operation of the display 710 to display data output from the nonvolatile memory 400, data output from the radio transceiver 720, or data output from the input device 730.

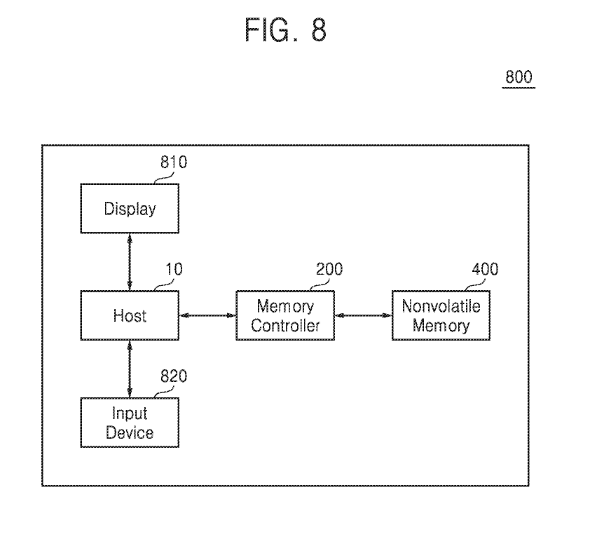

FIG. 8 is a block diagram of a data processing system 800 according to some embodiments of the disclosure. Referring to FIG. 8, the data processing system 800 including the memory controller 200 illustrated in FIG. 1, may be implemented as a personal computer (PC), a network server, a tablet PC, a netbook, an e-reader, a personal digital assistant (PDA), a portable multimedia player (PMP), an MP3 player, or an MP4 player.

The data processing system 800 includes a host 10, a nonvolatile memory 400, a memory controller 200 for controlling the data processing operations operation of the nonvolatile memory 400, a display 810 and an input device 820.

The host 10 may display data stored in the nonvolatile memory 400 through the display 810 according to data input through the input device 820. The input device 820 may be implemented by a pointing device such as a touch pad or a computer mouse, a keypad, or a keyboard.

The host 10 may control the overall operation of the nonvolatile memory 400 and the operations of the memory controller 200. According to some embodiments, the memory controller 200, which may control the operations of the nonvolatile memory 400, may be implemented as a part of the host 10 or as a separate chip.

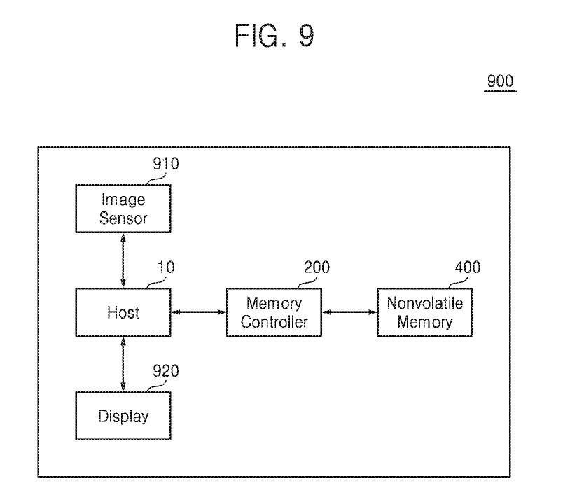

FIG. 9 is a block diagram of a data processing system 900 according to some embodiments of the disclosure. Referring to FIG. 9, the data processing system 900 may be implemented as an image processing device like a digital camera, a cellular phone equipped with a digital camera, or a smart phone equipped with a digital camera.

The data processing system 900 includes a host 10, the nonvolatile memory 400 and a memory controller 200 controlling the data processing operations, such as a write operation or a read operation, of the nonvolatile memory 400. The data processing system 900 further includes an image sensor 910 and a display 920.

The image sensor 910 included in the data processing system 900 converts optical images into digital signals and outputs the digital signals to the host 10 or the memory controller 200. The digital signals may be controlled by the host 10 to be displayed through the display 920 or stored in the nonvolatile memory 400 through the memory controller 200.

Data stored in the nonvolatile memory 400 may be displayed through the display 920 according to the control of the host 10 or the memory controller 200. The memory controller 200, which may control the operations of the nonvolatile memory 400, may be implemented as a part of the host 10 or as a separate chip.

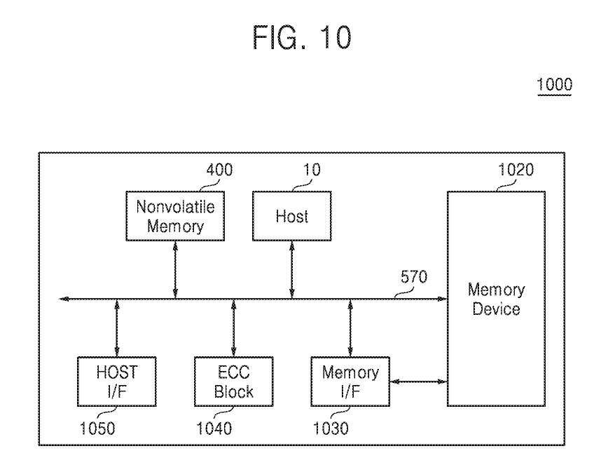

FIG. 10 is a block diagram of a data processing system 1000 according to some embodiments of the disclosure. The data processing system 1000 includes the nonvolatile memory 400 and a host 10 controlling the operations of the nonvolatile memory 400. The nonvolatile memory 400 may be implemented by nonvolatile memory such as a flash memory.

The data processing system 1000 also includes a memory device 1020, a memory interface 1030, an error correction code (ECC) block 1040, and a host interface 1050.

The host 10 connected with the data processing system 1000 may perform data communication with the memory device 1020 through the memory interface 1030 and the host interface 1050.

The ECC block 1040 is controlled by the host 10 to detect an error bit included in data output from the memory device 1020 through the memory interface 1030, correct the error bit, and transmit the error-corrected data to the host 10 through the host interface 1050. The host 10 may control data communication among the memory interface 1030, the ECC block 1040, the host interface 1050, and the nonvolatile memory 400 through a bus 570. The data processing system 1000 may be implemented as a flash memory drive, a USB memory drive, an IC-USB memory drive, or a memory stick.

A memory controller and a storage device including the same according to an embodiment of the disclosure are capable of analyzing data or a command received from a host and consuming power to be optimized for actual data transmission performance on the basis of a result of analyzing the data or the command, thereby increasing the efficiency of power.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

While the disclosure has been particularly shown and described with reference to the example embodiments illustrated in the drawings, these embodiments are merely examples. It would be obvious to those of ordinary skill in the art that these embodiments are to cover all modifications, equivalents, and alternatives falling within the scope of the disclosure. Accordingly, the technical scope of the disclosure should be defined based on the technical idea of the appended claims.

What is claimed is:

1. A memory controller of a nonvolatile memory device, the memory controller comprising:
a host interface configured to output at least one among a plurality of pieces of control information on the basis of data or a command received from a host; and
a lower-power mode entry controller configured to select and output at least one among a plurality of control signals on the basis of at least one among the plurality of pieces of control information, wherein:
the lower-power mode entry controller outputs the plurality of control signals to run a low-power mode of the nonvolatile memory device in which power consumption is decreased, and
the plurality of pieces of control information comprise:
operation information representing a read operation or a write operation;
pattern information representing a random operation or a sequential operation; and
speed information representing a throughput of the host per unit time.

2. The memory controller of claim 1, wherein the host interface comprises an operation detector configured to generate the operation information on the basis of the command or the data received from the host.

3. The memory controller of claim 1, wherein the host interface comprises a pattern detector configured to generate the pattern information on the basis of the command or the data received from the host.

4. The memory controller of claim 1, wherein the host interface measures the throughput of the host per unit time by counting blocks of data received for a unit time and generates the speed information on the basis of the measured throughput.

5. The memory controller of claim 1, wherein:
the plurality of control signals comprises a first control signal, a second control signal, a memory control signal, and a buffer control signal, and
the memory controller further comprises:
a power manager configured to generate a third control signal for controlling a power management integrated circuit (PMIC) on the basis of the first control signal;
a clock manager configured to control a clock signal of the memory controller on the basis of the second control signal;
a buffer manager configured to control a buffer of the nonvolatile memory device on the basis of the buffer control signal; and
a memory interface configured to control a nonvolatile memory of the nonvolatile memory device on the basis of the memory control signal.

6. The memory controller of claim 5, wherein the clock manager controls the clock signal by changing a frequency of the clock signal or performing clock gearing on the basis of the second control signal.

7. The memory controller of claim 5, wherein the lower-power mode entry controller comprises a mode selector configured to determine whether the low-power mode is to be entered by inserting one of the plurality of pieces of control information into a power table, and select one of a plurality of low-power modes stored in the power table when it is determined that the low-power mode is to be entered.

8. The memory controller of claim 7, wherein:
the lower-power mode entry controller further comprises a control signal generator configured to select and generate at least one among the plurality of control signals on the basis of the selected low-power mode, and
the control signal generator determines a point of time when the generated at least one control signal is to be output, and outputs the generated at least one control signal at the determined point of time.

9. The memory controller of claim 1, further comprising a central processing unit (CPU) configured to control or operate the lower-power mode entry controller.

10. The memory controller of claim 1, wherein the host interface comprises one of a serial advanced technology attachment (SATA) interface, a peripheral component interconnect express (PCIe) interface, a non-volatile memory express (NVMe) interface, a serial attached-small computer system interface (SCSI) (SAS), and a universal flash storage (UFS) interface.

11. A storage device which includes a power management integrated circuit (PMIC), a memory controller, a buffer, and a nonvolatile memory, wherein the memory controller comprises:
a host interface configured to output at least one among a plurality of pieces of control information on the basis of data or a command received from a host;
a lower-power mode entry controller configured to select and output at least one among a plurality of control signals on the basis of at least one among the plurality of pieces of control information; and
a central processing unit (CPU) configured to control or operate the lower-power mode entry controller, wherein:
the plurality of pieces of control information comprises:
operation information representing a read operation or a write operation;
pattern information representing a random operation or a sequential operation; and
speed information representing a throughput of the host per unit time, the host interface comprises:
an operation detector configured to generate the operation information on the basis of the command or the data received from the host;
a pattern detector configured to generate the pattern information on the basis of the command or the data received from the host; and
a speed measurer configured to generate the speed information on the basis of the data received from the host, and
the speed measurer measures the throughput of the host per unit time by counting blocks of data received for the unit time, and generates the speed information.

12. The storage device of claim 11, wherein:
the buffer stores a power table including predetermined values of a low-power mode of the storage device, and
the lower-power mode entry controller comprises a mode selector configured to determine whether the low-power mode is to be entered, by inserting at least one among the plurality of pieces of control information into the power table, and select one of a plurality of low-power modes stored in the power table when it is determined that the low-power mode is to be entered.

13. The storage device of claim 12, wherein:
the lower-power mode entry controller further comprises a control signal generator configured to select and generate at least one among the plurality of control signals on the basis of the selected low-power mode, and
the control signal generator determines a point of time when the generated at least one control signal is to be output and outputs the generated at least one control signal at the determined point of time.

14. The storage device of claim 13, wherein the control signal generator outputs the generated at least one control signal when a mode change command is received from the host.

15. The storage device of claim 13, wherein the control signal generator outputs the generated at least one control signal when the number of errors occurring in the nonvolatile memory is greater than a predetermined value.

16. A storage device comprising:
a nonvolatile memory;
a memory buffer; and
a memory controller that programs information into the nonvolatile memory, reads the programmed information from the nonvolatile memory, and controls the power consumed by the storage device in accordance with data or a command received from an external host, wherein:
the power consumed by the storage device is varied by controlling: (1) operating voltages provided to the nonvolatile memory, the buffer or the memory controller, (2) the frequency of a clock signal provided to the nonvolatile memory, the buffer or the memory controller, (3) whether the memory buffer is activated for temporarily storing buffer data communicated between the nonvolatile memory and the host, or (4) which one or more of a plurality of data storage regions within the nonvolatile memory is activated for operational use.

17. The storage device of claim 16, wherein the memory controller controls the power consumption according to:
a first mode of power consumption when the data or command received from the host indicates a sequential access of the nonvolatile memory, and
a second mode of power consumption, which differs from the first mode of power consumption, when the data or command received from the host indicates a random access of the nonvolatile memory.

18. The storage device of claim 16, wherein the memory controller controls the power consumption according to a communication throughput per unit of time, between the host and the storage device, indicated by the data or command received from the host.

19. The storage device of claim 16, wherein the power consumed by the storage device is varied by controlling at least two of items (1) through (4).

20. The storage device of claim 16, wherein the memory controller controls one or more of items (1) through (4) when the memory controller determines, from the data or command received from the host, that the host's maximum communication throughput is less than that of the storage device.
